(19) United States
(12) Patent Application Publication
(10) Pub. No.: US 2026/0225779 A1
(43) Pub. Date: Aug. 6, 2026

(54) LOCKING AND RELEASABLE OVERCAP, CONTAINER WITH OVERCAP, AND METHOD

(71) Applicant: Plastipak Packaging, Inc., Plymouth, MI (US)

(72) Inventors: Lia Eva Stinedurf, Brighton, MI (US); Jacob Mikula, Hazel Park, MI (US)

(21) Appl. No.: 19/532,577

(22) Filed: Feb. 6, 2026

Related U.S. Application Data
(60) Provisional application No. 63/754,896, filed on Feb. 6, 2025.

(51) Int. Cl. B65D 51/18; B65D 47/20; G01F 19/00

(52) U.S. Cl. CPC B65D 51/18; B65D 47/20; B65D 2203/00; B65D 2555/02; G01F 19/002

(57) ABSTRACT

An overcap for attachment to a portion of a container. The overcap includes one or more radially inwardly extending formations or lugs circumferentially disposed at or about an open end of the overcap. In embodiments, such one or more radially inward extending formations or lugs can be configured to move or pass vertically through or between a plurality of outward radial formations provided about a circumference of an opening portion of said container. In embodiments the overcap may serve as a measuring or dosing cup, and the overcap may be secured, released, and re-secured.

### CROSS-REFERENCE TO RELATED APPLICATION

This application claims priority to U.S. Provisional Patent Application No. 63/754,896, filed on Feb. 6, 2025, the contents of which is hereby incorporated by reference in its entirety.

### TECHNICAL FIELD

The present invention relates to overcaps and plastic containers that utilize overcaps, and methods for connecting or applying overcaps to such containers.

### BACKGROUND

Plastic containers, including those storing liquid contents, are widely employed in the industry. Such containers may include various forms of dispensers for dispensing contents, typically from a dispensing opening. Overcaps or closures may be used to cover such dispensers and may additionally serve as a measuring or dosing cup. However, application of such overcaps can involve additional steps, including application of a tape or other separate means for attaching or securing, to secure overcaps or closures to containers.

Among other things, it can be desirable to provide an overcap or closure that can be secured or locked in position, such as to protect a dispenser; that can be easily attached, detached, and re-attached to a container without requiring taping or other separate means for securing or attachment; and which may also serve as a measuring or dosing cup.

### SUMMARY

An overcap for attachment to a portion of a container is disclosed. The overcap includes one or more radially inward extending formations or lugs circumferentially disposed at or about an open end of the overcap. In embodiments, such one or more radially inward extending formations or lugs can be configured (e.g., sized and shaped) to move or pass vertically through or between a plurality of outward radial formations provided about a circumference of an opening portion of said container. The overcap may be secured, released, and re-secured.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a perspective view of an embodiment of an upper portion of a container with an overcap according to aspects or teachings of the present disclosure;

FIG. 2 is a front view of the upper portion of the container with an overcap, such as generally illustrated in FIG. 1;

FIG. 3 is a rear view of the upper portion of the container with an overcap, such as generally illustrated in FIG. 1;

FIG. 4 is a left side view of the upper portion of the container with an overcap, such as generally illustrated in FIG. 1;

FIG. 5 is a right side view of the upper portion of the container with an overcap, such as generally illustrated in FIG. 1;

FIG. 6 is a top plan view of the upper portion of the container with an overcap, such as generally illustrated in FIG. 1;

FIG. 7A is partial sectional representation of an opening portion of a container and an overcap shown in a locked position; FIG. 7B is a partial sectional representation of an opening portion of a container and an overcap shown in an unlocked position;

FIG. 8 is a top view representation of the feature-to-feature interaction associated with an overcap and an opening portion of a container; and

FIGS. 9-21 illustrate the removal, separation, and re-application of an overcap with respect to an opening portion of a container.

### DETAILED DESCRIPTION

Reference will now be made in detail to embodiments of the present disclosure, examples of which are described herein and illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention as defined herein and by appended claims.

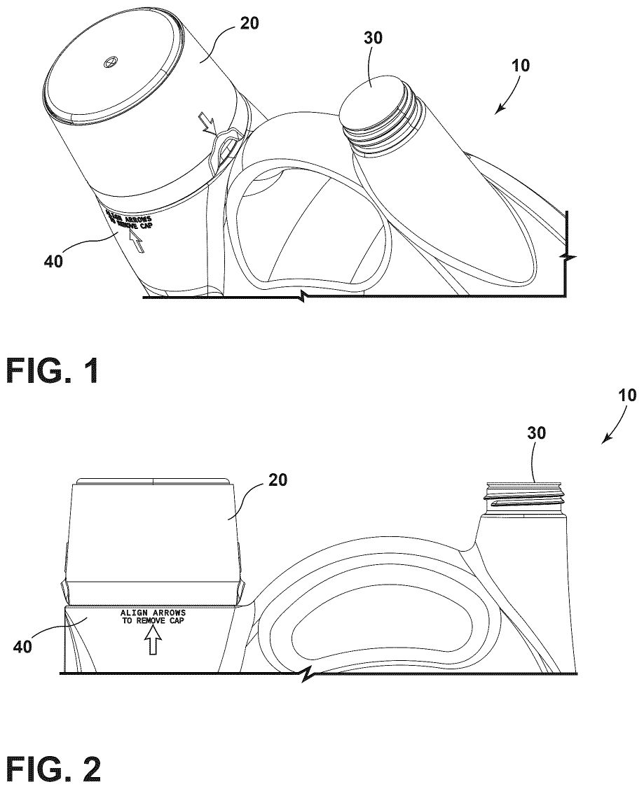

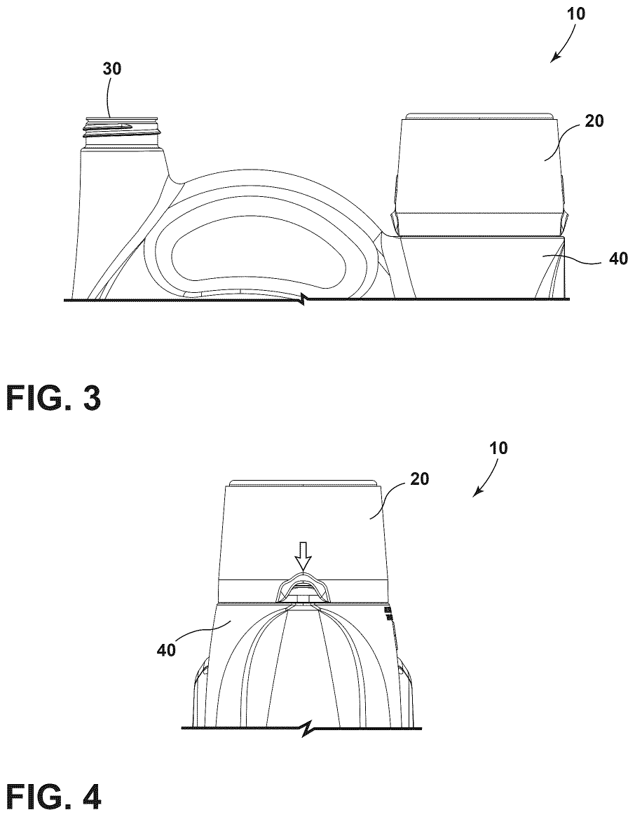

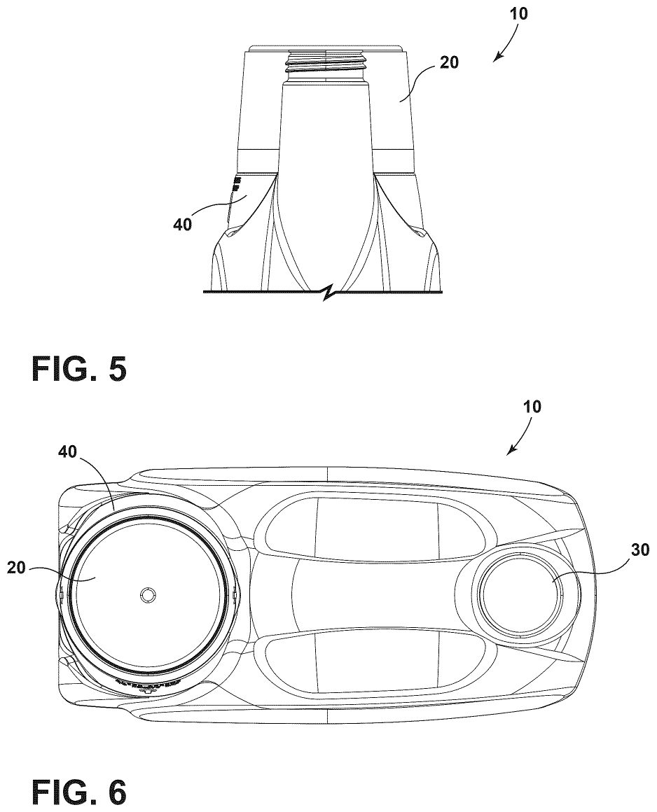

FIGS. 1-6 generally illustrate an embodiment of an upper portion of a container 10 and an overcap 20 in accordance with aspects and teachings of the present disclosure. While not limited to a specific size/volume, the illustrated embodiment of a container 10 may have more than one opening (e.g., an opening associated with the overcap 20 and an additional opening 30), and may have various storage capacities, including larger fluid capacities (e.g., more than 130 fluid ounces).

The container 10 may be comprised of one or more different plastic materials, may include recycled plastic material content, and may be in the form of a multi-layer container. For example and without limitation, the container 10 may be comprised of high density polyethylene (HDPE), polypropylene (PP), and/or polyethylene terephthalate (PET). Such containers may also be comprised of post consumer recycled (PCR) content. The overcap 20 also may be comprised of plastic, including those noted above, and for embodiments may be clear (transparent or see-through) or opaque. With embodiments, the container 10 and overcap 20 may both be comprised of recyclable plastic material. In embodiments, the overcap 20 may comprise a dosing cup and/or may include various markings, including measurement values or other information. Such markings may be formed as part of the overcap 20, including an integral part of the overcap formed as a single component.

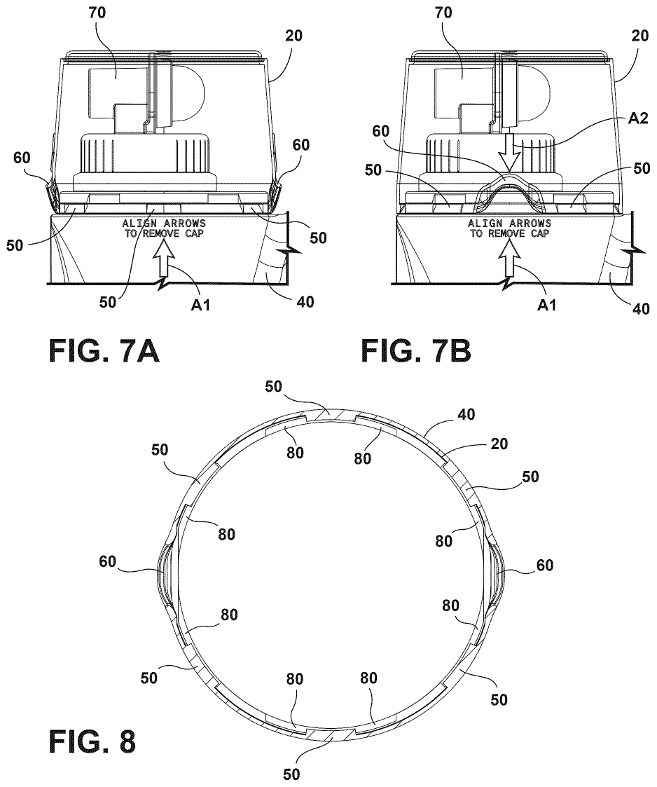

FIG. 7A generally illustrates an embodiment of an opening portion 40 of a container and an overcap 20, with the overcap in a locked position. FIG. 7B generally illustrates the embodiment of an opening portion 40 of a container and an overcap 20, with the overcap in an unlocked position. As shown in FIGS. 7A and 7B, the opening portion 40 of the container may include, inter alia, a reference marking or designation (e.g., arrow A1). As shown in FIG. 7B, an overcap 20 may include one or more radially inwardly extending formations or lugs 50 disposed at or about an open end of the overcap 20. In some implementations, radially inwardly extending formations or lugs 50 may be integrally formed as a single unit with the overcap 20. An overcap 20 may also include, inter alia, a reference marking or designation (e.g., arrow A2). An overcap may further include one or more offset edge portions 60, which may serve as a pouring spout and/or may generally coincide with a reference marking or designation (e.g., arrow A2). With embodiments, in an unlocked position, such as generally illustrated in FIG. 7B, the markings or designations of the overcap 20 (e.g., arrows A2) and the markings or designations of the opening portion 40 (e.g., arrows A1) may be generally vertically aligned.

In some embodiments or implementations, the interrelationship between the one or more radially inwardly extending formations or lugs 50 of the overcap 20 and the one or more radially inwardly extending formations or lugs 50 of the overcap 20 and the outward radial formations 80 of the opening portion 40 may be reversed. That is, while the principle of rotational engagement may be essentially the same for securing the components, the formations or lugs 50 of the overcap may extend radially outwardly, and the radial formations 80 of the opening portion 40 may extend inwardly.

While the markings or designations are illustrated in embodiments as arrows (e.g., arrow A1, arrow A2), the inventive concept is not limited to the illustrated reference markings shown, and any number of marks/designations, including lines, letters, symbols, and/or other marks/identifiers may be used to, among other things, visually indicate an alignment between the overcap 20 and the opening portion 40 of the container. Additionally, with some embodiments, a physical feature (such as an offset, e.g., pour spout) of an overcap 20 may serve as a reference marking or designation for alignment with an opening portion 40 of a container). In some embodiments, reference markings or designations with the overcap 20 and the opening portion may be optional (e.g., no arrows A1 and/or A2 may be provided). In such instances, the alignment of physical features to permit the formations or lugs 50 of an overcap 20 to pass vertically through correspondingly size circumferential radial openings disposed between outward radial formations 80 of the opening portion 40 may be all that is provided or necessary for alignment of the overcap 20 to the opening portion 40 and to allow related movement between such components to secure or remove the overcap 20.

As generally illustrated in FIGS. 7A and 7B, an overcap 20 may be sized to cover and protect a valve or dispenser 70. That is, in addition to possibly serving as a measuring or dosing cup, an overcap 20 may be sized and/or configured to protect a valve or dispenser 70, such as from unintentional contact with outside structures or elements. For example and without limitation, a valve or dispenser 70 may include a valve dispenser or a push-button spigot dispenser (e.g., such as generally illustrated in FIGS. 7A and 7B).

FIG. 8 is a top view representation of a feature-to-feature interaction associated with an overcap 20 and an opening portion 40 of a container such as shown in FIG. 7B (but rotated approximately 90 degrees, or a quarter-turn). As generally shown, one or more radially inwardly extending formations or lugs 50 of an overcap 20 which may circumferentially move around beneath or under a plurality of outward radial formations 80 of the opening portion 40 that are positioned vertically above such formations or lugs 50.

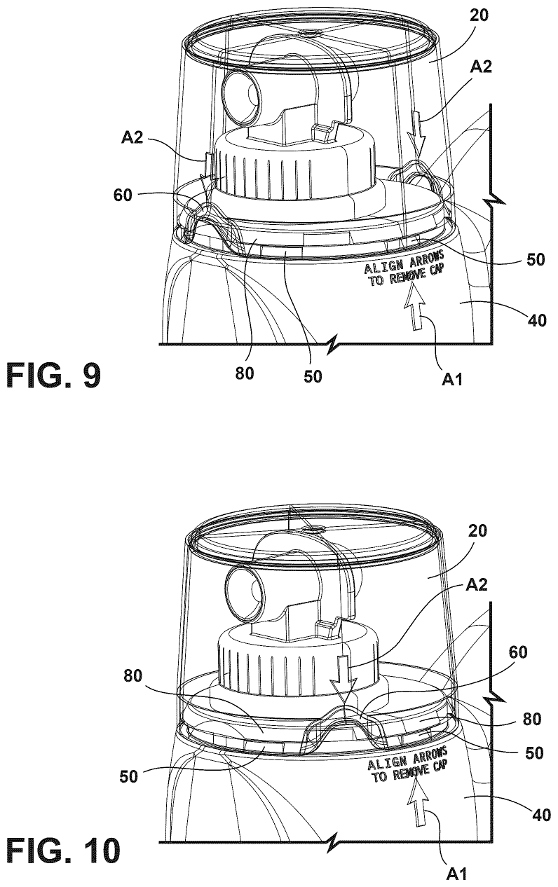

An embodiment of an overcap 20 in a non-open (or closed or locked) position is generally illustrated in FIG. 9. As generally shown, one or more radially inwardly extending formations or lugs 50 of an overcap 20 are circumferentially arranged beneath or under a plurality of outward radial formations 80 of the opening portion 40, preventing lifting or removal of the overcap 20 from the opening portion 40 of the container. In this overcap 20 secured position/configuration, the valve or dispenser 70 is covered and protected by the overcap 20. Among other things, during stacking or shipping, a secured overcap 20 can protect a valve or dispenser 70 from damage.

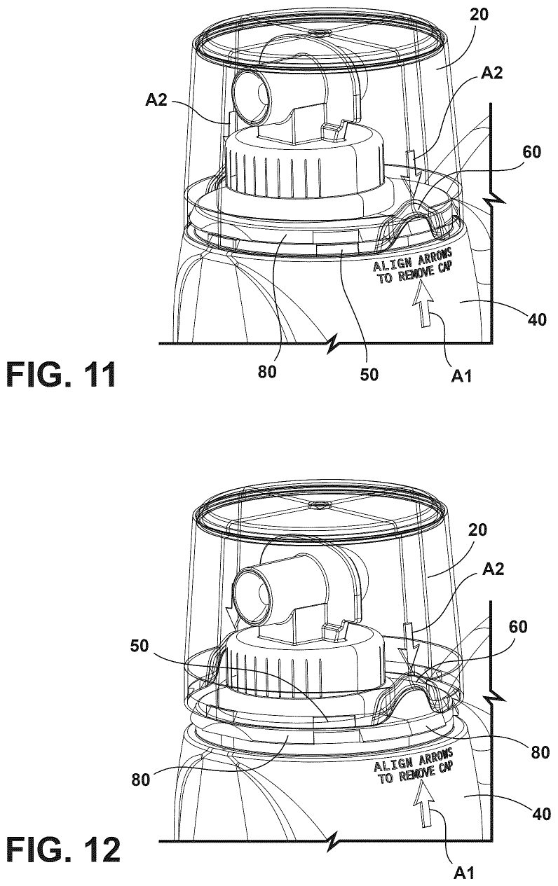

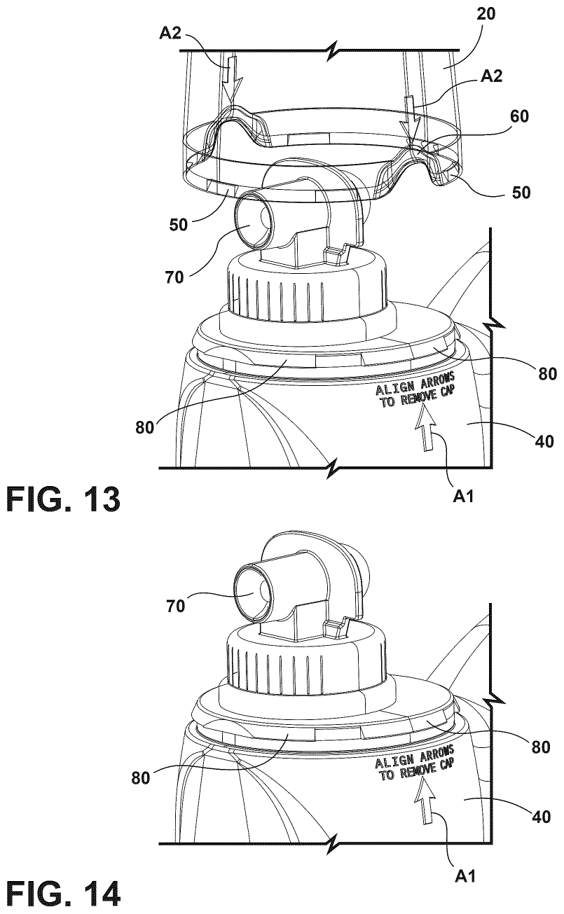

FIG. 10 depicts the overcap 20 of FIG. 9, but with a slight rotation in the counterclockwise direction. In this position/configuration, portions of the formations or lugs 50 of an overcap 20 are circumferentially arranged beneath or under portions of one or more outward radial formations 80 of the opening portion 40, still preventing lifting or removal of the overcap 20. With further counterclockwise rotation of the overcap 20, the overcap may come to the position/configuration generally illustrated in FIG. 11. In such position/configuration, the reference marking or designation of the opening portion 40 of the container (e.g., arrow A1) may come to substantial vertical alignment with the reference marking or designation of the overcap (e.g., arrow A2). In this position/configuration, the overcap 20 may be lifted from the opening portion 40, such as generally illustrated in FIG. 12. As shown in FIG. 12, the formations or lugs 50 of the overcap 20 are generally aligned to move through or lift through correspondingly sized radial spacings between outward radial formations 80 of the opening portion. FIG. 13 generally illustrates an overcap 20 that is lifted above and has substantially cleared the valve or dispenser 70. FIG. 14 generally illustrates the full removal of an overcap 20 from an opening portion 40 of the container.

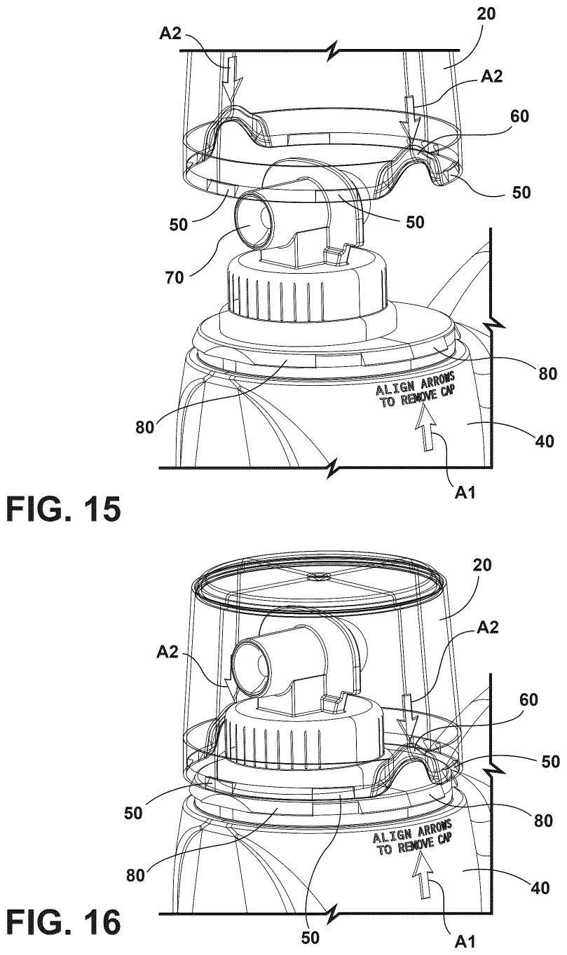

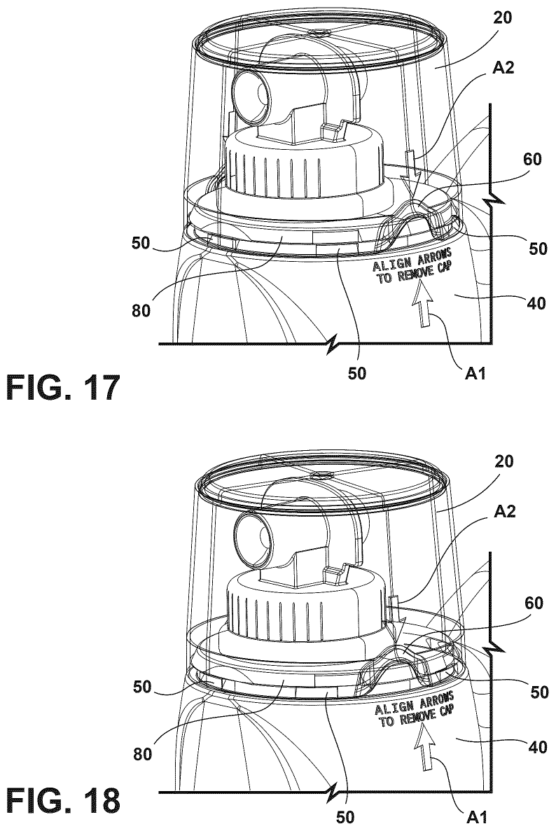

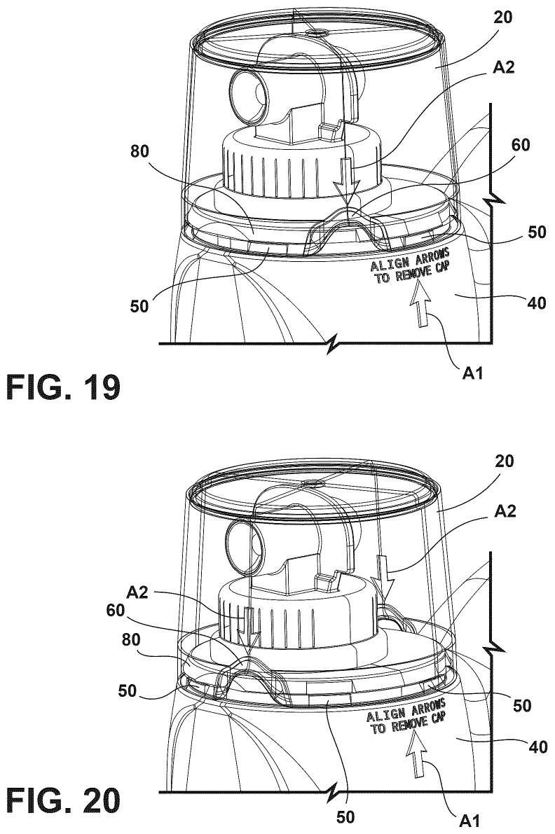

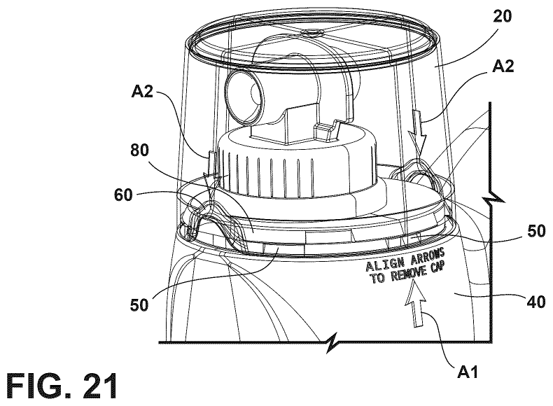

FIGS. 15-21 generally illustrate a reverse or inverse of the overcap removal process generally illustrated in FIGS. 10-14. As generally shown in FIG. 16, an overcap 20 is lowered such that the reference marking or designation of the overcap is substantially in a vertical alignment such that formations or lugs 50 of an overcap 20 may pass through correspondingly sized spacings between outward radial formations 80 of the opening portion 40. As shown, reference markings or designations associated with the overcap 20 and the opening portion 40 of the container, such as the arrows A1 and A2 in FIG. 16, may be included and utilized to facilitate the alignment and seating of the overcap, such as further shown in FIGS. 17 and 18. As generally illustrated in FIGS. 19-21, once re-seated, the overcap 20 may be turned clockwise to secure or lock the overcap 20 into position with respect to the opening portion 40 of the container. The process of removing and re-attaching the overcap 20 may be repeated by a user as desired.

The disclosure includes, without limitation, the following embodiments:
1. An overcap for attachment to an opening portion of a container, the overcap comprising: an open end; and one or more radially inwardly extending formations or lugs circumferentially disposed at or adjacent the open end of the overcap; wherein the one or more radially inwardly extending formations or lugs are configured to vertically pass through radial spacings disposed between a plurality of outward radial formations provided about a circumference of such opening portion of such container when the overcap is vertically aligned with such opening portion in an unlocked position, and to be positioned beneath at least a portion of the plurality of outward radial formations when the overcap is in a locked position.
2. The overcap of embodiment 1, wherein the overcap is securable by rotation relative to the container such that, in a secured orientation, the formations or lugs are circumferentially arranged beneath the outward radial formations to prevent lifting or removal of the overcap.
3. The overcap of any of the preceding embodiments, further comprising at least one reference marking or physical alignment feature on the overcap that, when aligned with a corresponding reference marking or physical alignment feature on the opening portion of the container, indicates an alignment orientation at which the formations or lugs pass vertically through radial spacings between the outward radial formations.
4. The overcap of any of the preceding embodiments, wherein the physical alignment feature comprises an offset edge portion serving as a pouring spout.
5. The overcap of any of the preceding embodiments, further comprising measurement markings arranged to enable use of the overcap as a measuring or dosing cup when detached from the container.
6. The overcap of any of the preceding embodiments, wherein, when secured to the opening portion of the container, the overcap covers and protects a valve or dispenser of the container.
7. The overcap of any of the preceding embodiments, wherein the overcap is comprised of a plastic material selected from the group consisting of high density polyethylene, polypropylene, and polyethylene terephthalate.
8. The overcap of any of the preceding embodiments, wherein the overcap is transparent or clear.
9. The overcap of any of the preceding embodiments, wherein the radially inwardly extending formations or lugs are integrally formed as a single unit with the overcap.
10. A method of securing an overcap relative to a container, comprising: aligning a reference marking or physical alignment feature on the overcap with a corresponding reference marking or physical alignment feature on an opening portion of the container; advancing the overcap so that radially inward extending formations or lugs of the overcap pass vertically through radial spacings between outward radial formations of the opening portion; rotating the overcap to a secured orientation in which the formations or lugs are arranged beneath at least a portion of the outward radial formations to lock the overcap and cover a valve or dispenser.
11. The method of embodiment 10, including releasing the overcap by rotating back to the alignment orientation and withdrawing the overcap.
12. The method according to any of the preceding embodiments, wherein the physical alignment feature comprises an offset edge portion of the overcap serving as a pouring spout.
13. The method according to any of the preceding embodiments, wherein the valve or dispenser comprises a push-button spigot.
14. The method according to any of the preceding embodiments, wherein the overcap is comprised of a plastic material selected from the group consisting of high density polyethylene, polypropylene, and polyethylene terephthalate.
15. The method according to any of the preceding embodiments, wherein the overcap is clear or opaque.
16. The method according to any of the preceding embodiments, further comprising using the overcap as a measuring or dosing cup when removed from the container.
17. A container assembly comprising: a container having an opening portion with a plurality of outward radial formations disposed circumferentially about the opening portion, the plurality of outward radial formations define radial spacings therebetween, and a valve or dispenser positioned above or about the opening portion; and an overcap having one or more radially inward extending formations or lugs circumferentially disposed at or about an open end of the overcap, the overcap configured to cover and protect the valve or dispenser when the overcap is secured to the container; wherein the one or more radially inward extending formations or lugs are configured to pass vertically through the radial spacings when the overcap is in a first rotational position relative to the opening portion and are configured to be disposed beneath the plurality of outward radial formations when the overcap is in a second rotational position relative to the opening portion.
18. The container assembly of embodiment 17, wherein the opening portion comprises a reference marking or feature for alignment with a corresponding reference marking or feature on the overcap.
19. The container assembly according to any of the preceding embodiments, wherein the container and the overcap both are comprised of recyclable plastic material.
20. The container assembly according to any of the preceding embodiments, wherein the overcap is configured to be repeatedly moved between the first rotational position and the second rotational position to alternately detach and secure the overcap to the container.
21. An overcap for attachment to an opening portion of a container, the overcap comprising: an open end; and one or more radially outwardly extending formations or lugs circumferentially disposed at or adjacent the open end of the overcap; wherein the one or more radially outwardly extending formations or lugs are configured to vertically pass through radial spacings disposed between a plurality of inwardly radial formations provided about a circumference of such opening portion of such container when the overcap is vertically aligned with such opening portion in an unlocked position, and to be positioned beneath at least a portion of the plurality of inwardly radial formations when the overcap is in a locked position.

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are intended to be inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

It is intended that all matter contained in the above description or shown in the accompanying drawings shall be interpreted as illustrative only and not limiting. Changes in detail or structure may be made without departing from the present disclosure.

What is claimed is:

1. An overcap for attachment to an opening portion of a container, the overcap comprising:
an open end; and
one or more radially inwardly extending formations or lugs circumferentially disposed at or adjacent the open end of the overcap;
wherein the one or more radially inwardly extending formations or lugs are configured to vertically pass through radial spacings disposed between a plurality of outward radial formations provided about a circumference of such opening portion of such container when the overcap is vertically aligned with such opening portion in an unlocked position, and to be positioned beneath at least a portion of the plurality of outward radial formations when the overcap is in a locked position.

2. The overcap of claim 1, wherein the overcap is securable by rotation relative to the container such that, in a secured orientation, the formations or lugs are circumferentially arranged beneath the outward radial formations to prevent lifting or removal of the overcap.

3. The overcap of claim 1, further comprising at least one reference marking or physical alignment feature on the overcap that, when aligned with a corresponding reference marking or physical alignment feature on the opening portion of the container, indicates an alignment orientation at which the formations or lugs pass vertically through radial spacings between the outward radial formations.

4. The overcap of claim 3, wherein the physical alignment feature comprises an offset edge portion serving as a pouring spout.

5. The overcap of claim 1, further comprising measurement markings arranged to enable use of the overcap as a measuring or dosing cup when detached from the container.

6. The overcap of claim 1, wherein, when secured to the opening portion of the container, the overcap covers and protects a valve or dispenser of the container.

7. The overcap of claim 1, wherein the overcap is comprised of a plastic material selected from the group consisting of high density polyethylene, polypropylene, and polyethylene terephthalate.

8. The overcap of claim 1, wherein the overcap is transparent or clear.

9. The overcap of claim 1, wherein the radially inwardly extending formations or lugs are integrally formed as a single unit with the overcap.

10. A method of securing an overcap relative to a container, comprising:
aligning a reference marking or physical alignment feature on the overcap with a corresponding reference marking or physical alignment feature on an opening portion of the container;
advancing the overcap so that radially inward extending formations or lugs of the overcap pass vertically through radial spacings between outward radial formations of the opening portion;
rotating the overcap to a secured orientation in which the formations or lugs are arranged beneath at least a portion of the outward radial formations to lock the overcap and cover a valve or dispenser.

11. The method of claim 10, including releasing the overcap by rotating back to the alignment orientation and withdrawing the overcap.

12. The method of claim 10, wherein the physical alignment feature comprises an offset edge portion of the overcap serving as a pouring spout.

13. The method of claim 10, wherein the valve or dispenser comprises a push-button spigot.

14. The method of claim 10, wherein the overcap is comprised of a plastic material selected from the group consisting of high density polyethylene, polypropylene, and polyethylene terephthalate.

15. The method of claim 10, wherein the overcap is clear or opaque.

16. The method of claim 10, further comprising using the overcap as a measuring or dosing cup when removed from the container.

17. A container assembly comprising:
a container having an opening portion with a plurality of outward radial formations disposed circumferentially about the opening portion, the plurality of outward radial formations define radial spacings therebetween, and a valve or dispenser positioned above or about the opening portion; and
an overcap having one or more radially inward extending formations or lugs circumferentially disposed at or about an open end of the overcap, the overcap configured to cover and protect the valve or dispenser when the overcap is secured to the container;
wherein the one or more radially inward extending formations or lugs are configured to pass vertically through the radial spacings when the overcap is in a first rotational position relative to the opening portion and are configured to be disposed beneath the plurality of outward radial formations when the overcap is in a second rotational position relative to the opening portion.

18. The container assembly of claim 17, wherein the opening portion comprises a reference marking or feature for alignment with a corresponding reference marking or feature on the overcap.

19. The container assembly of claim 17, wherein the container and the overcap both are comprised of recyclable plastic material.

20. The container assembly of claim 17, wherein the overcap is configured to be repeatedly moved between the first rotational position and the second rotational position to alternately detach and secure the overcap to the container.

21. An overcap for attachment to an opening portion of a container, the overcap comprising:
an open end; and
one or more radially outwardly extending formations or lugs circumferentially disposed at or adjacent the open end of the overcap;
wherein the one or more radially outwardly extending formations or lugs are configured to vertically pass through radial spacings disposed between a plurality of inwardly radial formations provided about a circumference of such opening portion of such container when the overcap is vertically aligned with such opening portion in an unlocked position, and to be positioned beneath at least a portion of the plurality of inwardly radial formations when the overcap is in a locked position.
